(19) United States
(12) Patent Application Publication
(10) Pub. No.: US 2008/0078266 A1
(43) Pub. Date: Apr. 3, 2008

(54) Jig particularly for the positioning of articles

(75) Inventors: Sven Soetebier, Ladenburg (DE); Soenke Kock, Vasteras (SE); Waldi Wolfgang, Nussloch-Maisbach (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/902,866

(22) Filed: Sep. 26, 2007

(30) Foreign Application Priority Data
Sep. 29, 2006 (DE) 10 2006 046 758.2

(51) Int. Cl. G05G 11/00; B25B 11/00; B25J 9/06

(52) U.S. Cl. 74/490.13

(57) ABSTRACT

A jig particularly for the positioning of articles (1), with length-adjustable props (2), with a base part (3), with a receptacle (4) for the article (1), the props (2) being arranged between the base part (3) and the receptacle (4) and being in each case mounted movably there, and with a drive and control for adjusting the props (2), is specified. At least one pair of props (5) is formed from two props (2) in such a way that the two props (2) of the pair of props (5) extend parallel, thus resulting in the form of a parallelogram.

The present invention relates to a jig particularly for the positioning of at least one article, with length-adjustable props, with a base part, with a receptacle for the article, the props being arranged between the base part and receptacle and being in each case mounted there in an articulated manner, and with a drive and a control for adjusting the props, according to Patent DE 10 2006 011 823.5.

Such jigs for positioning serve for bringing an article into a desired position and holding it in this. Such an article is often a workpiece which with the aid of the jig is brought into this position and retained there, so that machining, for example by a robot, can then take place. Also, by means of such a jig, the article can, if required, be moved into further positions in which further machining steps can take place. The article may also be a tool which is brought into different positions for the purpose of machining a workpiece.

One possible field of use of a jig for the positioning of articles is, for example, the automobile industry, where, for example, bodies, etc. are machined automatically by means of robots on automatic production lines.

The props are length-adjustable and can be pivoted in space. The movements of the props are generated by drives. Control devices control the movement sequence and the final coordinates of the desired position.

Thus, for example, U.S. Pat. No. 5,272,805 has disclosed a jig for the positioning of an article, which jig has a plate with a plurality of props which are arranged independently of one another and on which a workpiece, which may be composed of a plurality of parts, can be positioned. In the case of the jig, a regulating device is provided, which measures the forces introduced into the props on account of the weight of the article and adjusts the props accordingly, so that the weight of the article can be held, even when, for example, changing external forces act on the article. Two or more of the props can be coupled mechanically to one another, in order to generate a particular movement of the article, while restricting degrees of freedom. The props coupled to one another in this case stand at an angle to one another, so that flexural or torsional moments may act on them. Moreover, the known jig requires a high outlay in terms of cost on account of the control and regulating device. The props have to be equipped with sensors which send suitable signals to the control and regulating device. When articles of greater weight are to be positioned, the rigidity requirements are likewise increased, and a correspondingly more complicated control and regulating device is required. The jig cannot react flexibly to highly diverse requirements and applications, and therefore the possibilities for the use of this jig are relatively limited.

U.S. Pat. No. 5,987,726 has disclosed a jig of the type initially mentioned. This possesses a base plate and a reception plate which are connected to one another by means of props which are of variable length. The individual props are inclined at an angle to one another and can be actuated independently of one another. Here, too, the props are subjected to high flexural and torsional moments, and the control and regulating devices for adjusting the props are complicated.

The object of the invention is to improve further the jig of the type initially mentioned, stability and flexibility for different applications being increased and the production and maintenance costs being reduced.

This object is achieved, according to the invention, by means of the features of patent claim 1.

Accordingly, a jig of the type in question is developed in such a way that at least one pair of props consisting of two props is provided, and in such a way that the two props of the pair of props extend parallel, thus resulting in the form of a parallelogram.

It was recognized, according to the invention, that stability can be improved and even wear-induced maintenance and repair costs can be avoided if a pair of props, which has the form of a parallelogram, is formed in each case from two parallel props. This ensures that, on the one hand, each prop absorbs forces individually, but, on the other hand, each pair of props, considered as a pair of forces, can also absorb a moment.

There are in this case the following possibilities for arranging the drive and control units:

according to a first embodiment, at least one prop of at least one pair of props can be activated for length adjustment by means of a drive and control device.

In this case, according to a further advantageous refinement of the invention, the drive device can be assigned spatially to the at least one prop and can be movable together with the latter. In this case, the drive and control device can form a spatial unit with one another. There is also the possibility, however, that the control device is arranged spatially separately from the drive device, if appropriate is accommodated in a switch cabinet.

The props of the pair of props are mounted movably, that is to say in an articulated manner, on the receptacle side and on the base-part side, so that the adjustment of the article in space can be carried out. However, the receptacle itself is fixedly connected to the receptacle-side end of the pair of props, so that the individual props can pivot about their axis of articulation, but the spatial distance between the axes of articulation is invariable. The receptacle can consequently be moved in all three directions of the spatial coordinate system, and also the angular position of the receptacle with respect to the base part can be adjusted according to requirements. The position of the base part can, of course, also be varied.

According to one embodiment, the base part may be present as a platform, on the top side of which the pair of props is arranged. However, any other form of supporting framework, which allows a spatially defined arrangement of the pair of props, may also be envisaged. For high stability in terms of articles of different size and weight which are to be positioned, it is advantageous if six props are provided, since, as a result, high torsional moments in the props are avoided and tensile and compressive forces predominate. With a view to minimizing the production costs, it is then expedient, in turn, to design these six props as three pairs of props.

A version of the jig according to the invention with three pairs of props, which is advantageous in terms of a compact design, is distinguished in that the base-part-side ends and the receptacle-side ends of the three pairs of props are arranged in each case in the form of an imaginary triangle. With a view to high stability, it is preferable to design the distance between the receptacle-side ends of the three pairs of props so as to be smaller than the distance between the base-part side ends of the three pairs of props, so that the imaginary triangle in the region of the receptacle is smaller than the imaginary triangle in the region of the base part.

The imaginary triangle may, according to the invention, be equilateral.

However, an isosceles design of the imaginary triangle is also possible. This isosceles configuration of the triangle leads, at least in one direction of space, to an even more compact type of construction, since it can have angles smaller than 60°. The space or room requirement can thereby be optimized. This is useful, for example, when the jig for positioning is arranged on a production line, since there is usually little space available here between the robots, conveyor belts, structural parts, etc.

Finally, the imaginary triangle formed by the base-part side ends and the imaginary triangle formed by the receptacle-side ends may be rotated with respect to one another. The base area of the base platform, plus the further structural parts, can thereby be minimized within specific limits. Moreover, a positioning jig can react flexibly to different requirements, in that the angle of rotation between the receptacle-side imaginary triangle and the base-part side imaginary triangle is varied. The smaller the angle of rotation is in this case, the higher the rigidity. Also, rigidity in the horizontal direction and flexural rigidity are increased. Tests have shown that the distribution of the forces to the six props is more uniform in the relatively rotated variant.

In a further advantageous refinement of the jig according to the invention with at least three pairs of props, the base-part-side ends of at least two pairs of props lie opposite one another on the first and second line which run parallel to one another (pivot axes B), and the base-part-side ends of the third pair of props lie on a third line which runs perpendicularly with respect to the first and the second line and which forms the pivot axis (B) of the third pair of props.

With regard to the pairs of props lying opposite one another, two arrangement variants in respect of the base-part-side ends may be provided. On the one hand, the base-part-side ends of the pairs of props lying opposite one another may be at no distance from another in the direction of their parallel bearing axes, so that this may be referred to as a respective symmetry. On the other hand, the base-part-side ends of the pairs of props lying opposite one another could also be at a distance from one another in the direction of their parallel bearing axes, so that an offset arrangement is obtained. Both arrangement variants afford a latitude for space-saving and cost-effective solutions for specific applications, even if the stability requirements in the absorption of torques have to be a little lower.

In this case, to achieve high stability, as in the arrangement in the form of an imaginary triangle too, the receptacle-side ends of the pairs of props may be at a shorter distance from one another than the base-part-side ends of the pairs of props. In this case, for example, the arrangement of the base-part-side ends of the pairs of props could be repeated by their receptacle-side ends, but with shorter distances.

According to a preferred variant, the receptacle-side ends of the two pairs of props lying opposite one another may also form an aligned row on an imaginary line parallel to the bearing axes of the base-part-side ends of the pairs of props lying opposite one another. It is thus possible to provide particularly space-saving receptacles for articles.

These variants may be gathered from claims 15 to 18.

A further advantageous refinement of the invention may be to the effect that the receptacle-side ends of each of the two pairs of props lying opposite one another span at least partially an imaginary line extending parallel to the pivot axis or to the first and the second line of the base-part-side end of the pair of props in each case lying opposite one another; in this case, the receptacle-side ends of the props of the pairs of props lying opposite one another may lie on both sides of the imaginary fourth line, the props of the two pairs of props crossing over the imaginary fourth line.

The stability-increasing variant having the props crossing the imaginary fourth line and also the variant of the aligned row of receptacle-side ends presuppose that there has to be, parallel to the bearing axes, a certain distance between the receptacle-side and the base-part-side ends of a pair of props of the two pairs of props lying opposite one another. If this distance is not present, at least the pairs of props lying opposite one another must be at a distance from one another parallel to the bearing axis.

In the advantageous version in question of the jig according to the invention with two pairs of props lying opposite one another and with one pair of props extending orthogonally thereto, the plate-shaped base part and also the receptacle could be of rectangular design. Circular or elliptical or even arbitrarily shaped receptacles may also be considered as a workpiece carrier or tool carrier.

All the pairs of props of the versions outlined hitherto could be equipped cost-effectively with only one drive and control unit in each case or with at least one drive unit and an associated encoder for detecting the drive position. If, however, a particularly flexible behaviour in terms of position variations and a homogeneous load distribution are to be achieved, then a further variant provides for driving at least two props of a pair of props separately. Preferably, the pair of props with the two separately driven props could be the pair of props extending orthogonally with respect to the two pairs of props lying opposite one another. As a result, for example, a pivoting movement of the receptacle could be brought about, in order to counteract flexural moments which are caused by the article, or a controlled pivoting movement could be exerted on the article as an additional movement possibility. Substantial independence of direction is afforded within a defined movement range.

The next advantageous version of the jig according to the invention is concerned with the design of the base part in the form of a body, on the circumference of which the pair of props or a plurality of pairs of props is or are arranged. In this case, the base part may be in the form of a cube, three side faces of the cube being assigned in each case a pair of props, and these extending approximately orthogonally with respect to one another. As a result, it becomes possible to design the receptacle as a spatial structure, for example as a frame-shaped structural part, and consequently to increase the possibility of using the jig according to the invention according to the most diverse possible requirements in spatial terms and in terms of possible articles. The frame-shaped structural part brings to mind suggestions in the area of motor vehicle technology, where the holding of bumper bars or fenders often presents problems. The pairs of props may also be assigned to more than three sides of the cube. Different receptacles for specific pairs of props and different functional assignments could also be envisaged. While tools are fastened to two pairs of props, the remaining pairs of props may hold a structural part on their common receptacle or on their separate receptacles.

These and further advantageous refinements and improvements of the invention may be gathered from the further subclaims.

The invention and also further advantageous refinements and improvements and further advantages of the invention will be explained and described in more detail with reference to the drawing which illustrates some exemplary embodiments of the invention and in which:

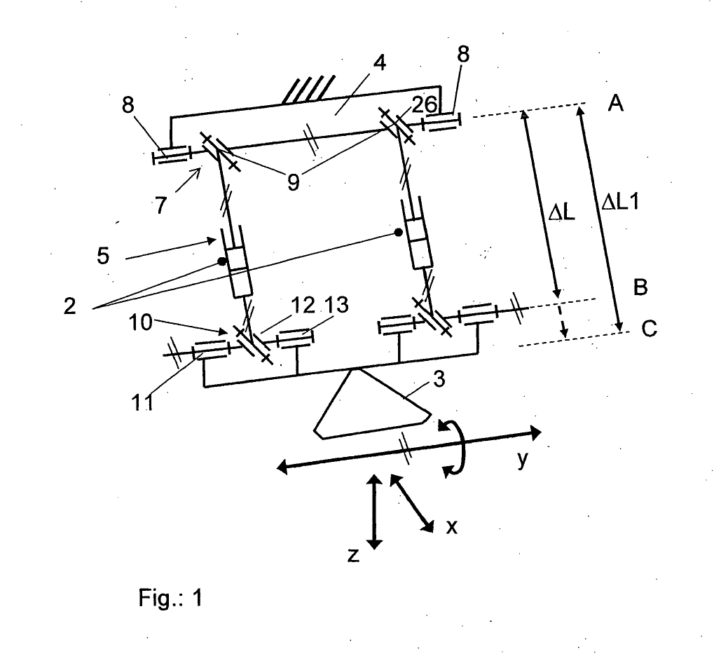

FIG. 1 shows a basic diagram of a pair of props of the jig according to the invention,

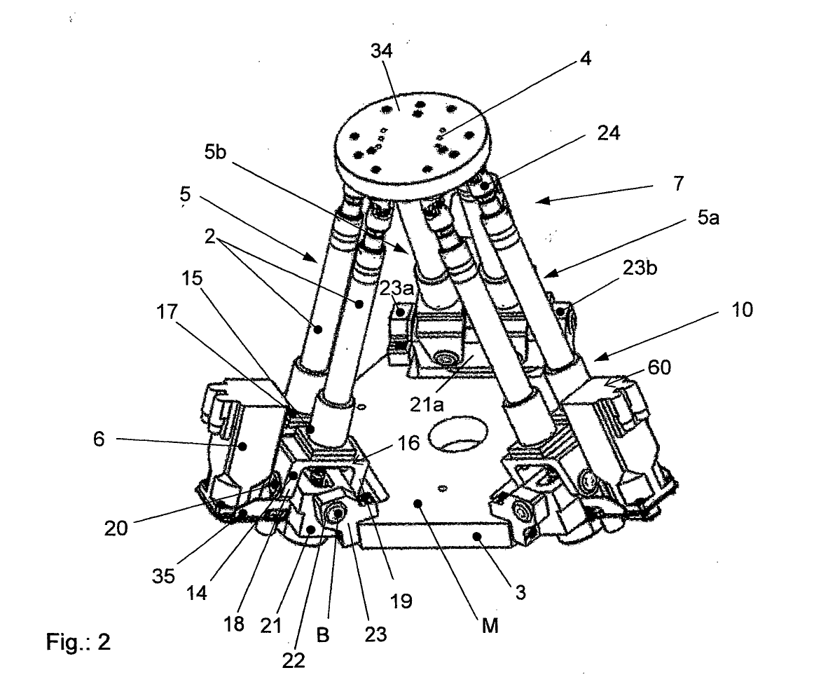

FIG. 2 shows a perspective illustration of a first exemplary embodiment of the jig according to the invention,

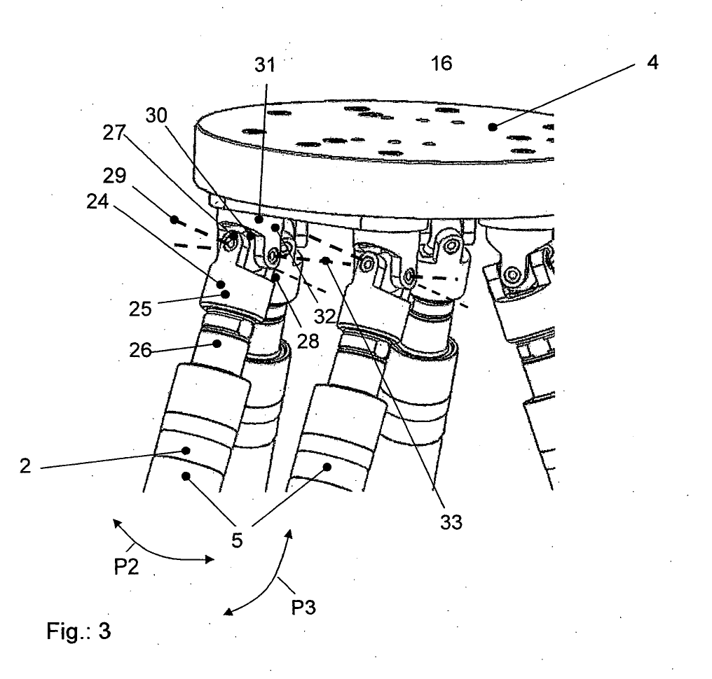

FIG. 3 shows, in an enlarged perspective illustration, a detail from FIG. 2 relating to the receptacle-side ends of a pair of props,

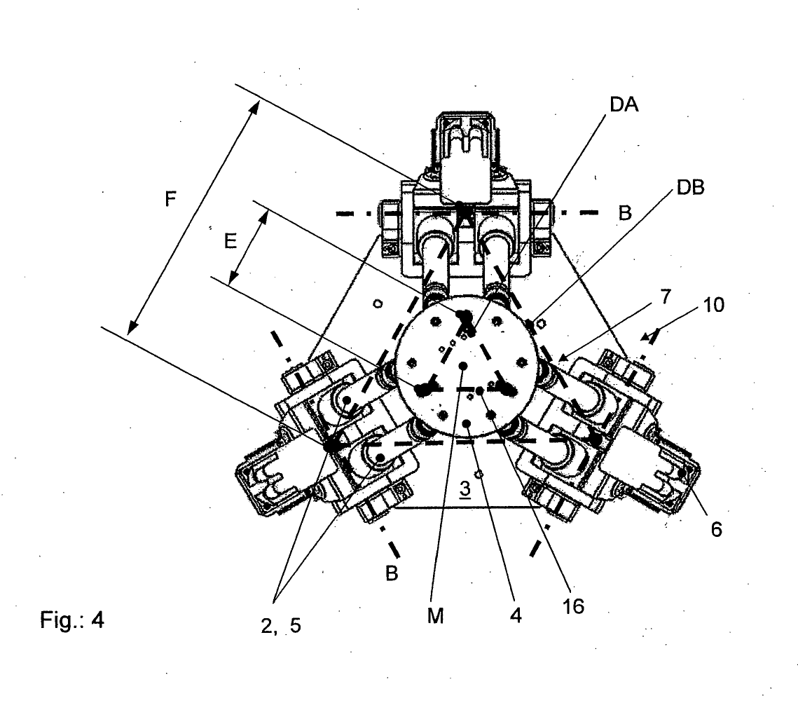

FIG. 4 shows a top view of the jig according to FIG. 2,

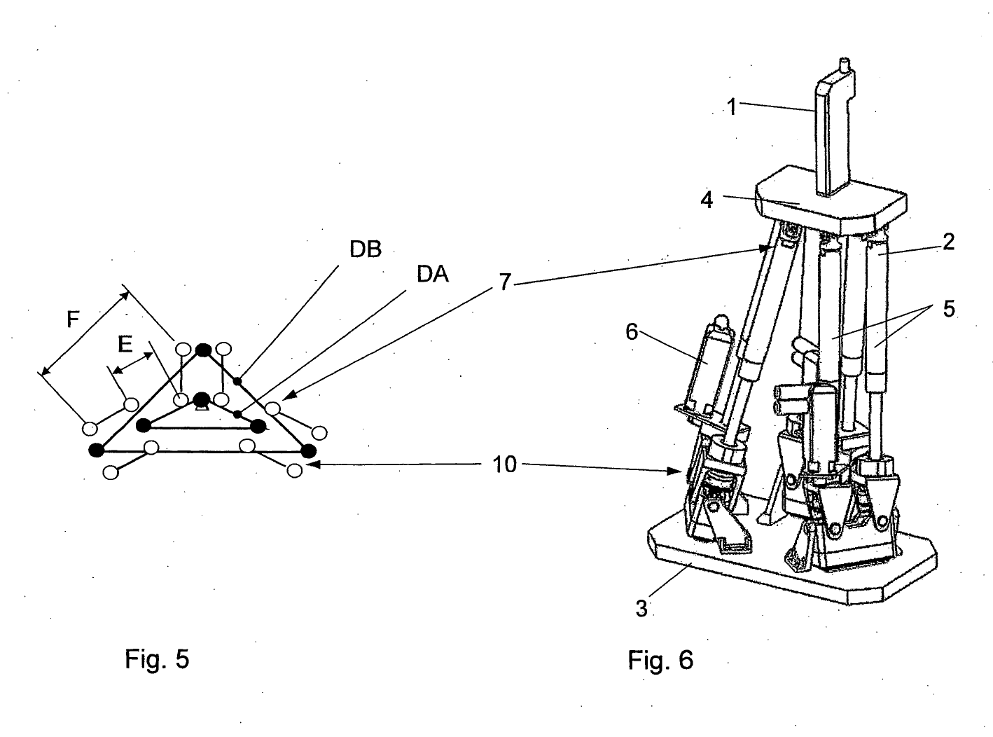

FIG. 5 shows a diagrammatic illustration of a first variant of the first exemplary embodiment of the jig according to the invention,

FIG. 6 shows a diagrammatic illustration of an exemplary embodiment of a positioner according to the variant shown in FIG. 5,

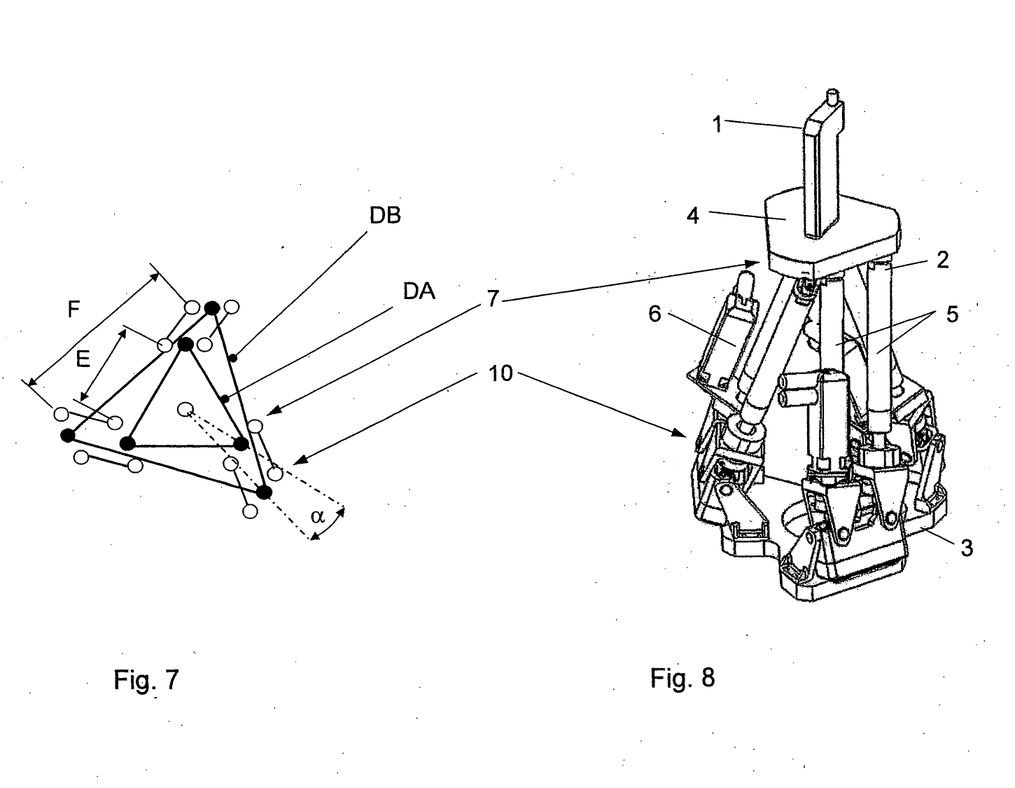

FIG. 7 shows a diagrammatic illustration of a second variant of the first exemplary embodiment of the jig according to the invention,

FIG. 8 shows a diagrammatic illustration of an exemplary embodiment according to the variant shown in FIG. 7, corresponding to that of FIG. 6,

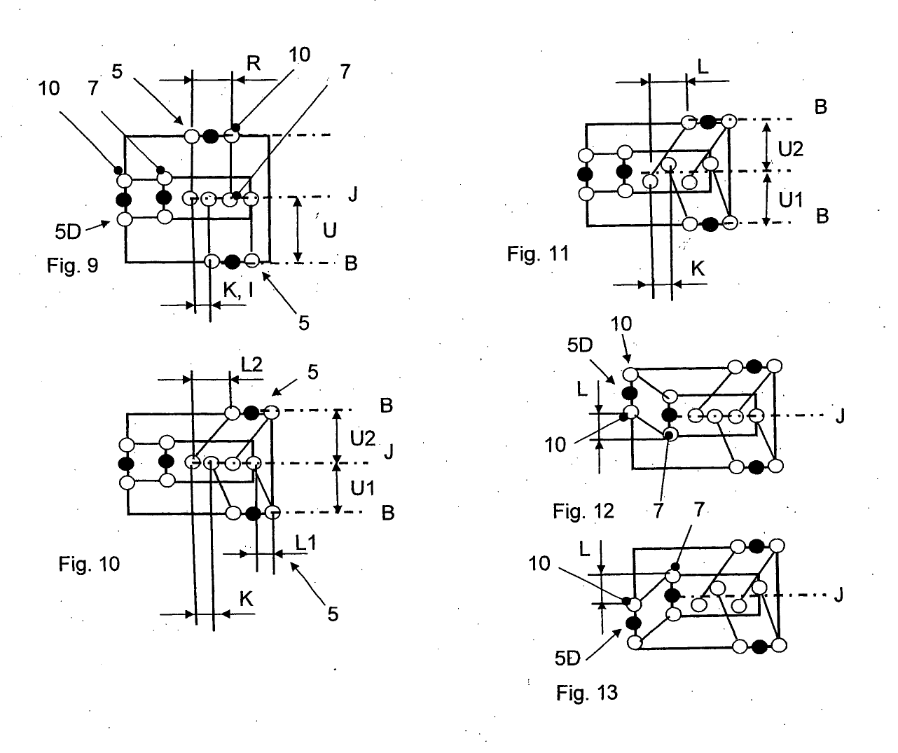

FIGS. 9 to 13 show some variants of the jig according to the invention in a diagrammatic illustration,

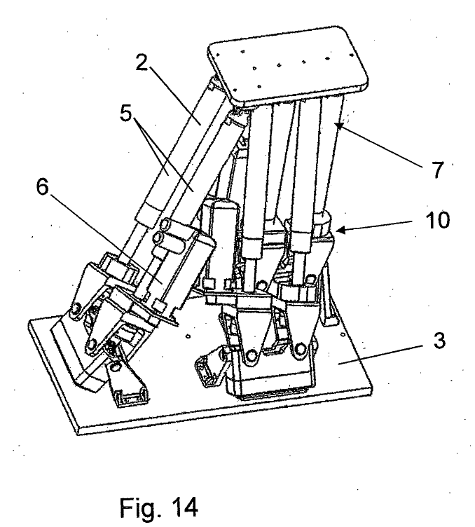

FIG. 14 shows a diagrammatic illustration of an exemplary embodiment of a positioner according to a variant shown in FIGS. 9, 10 and 11,

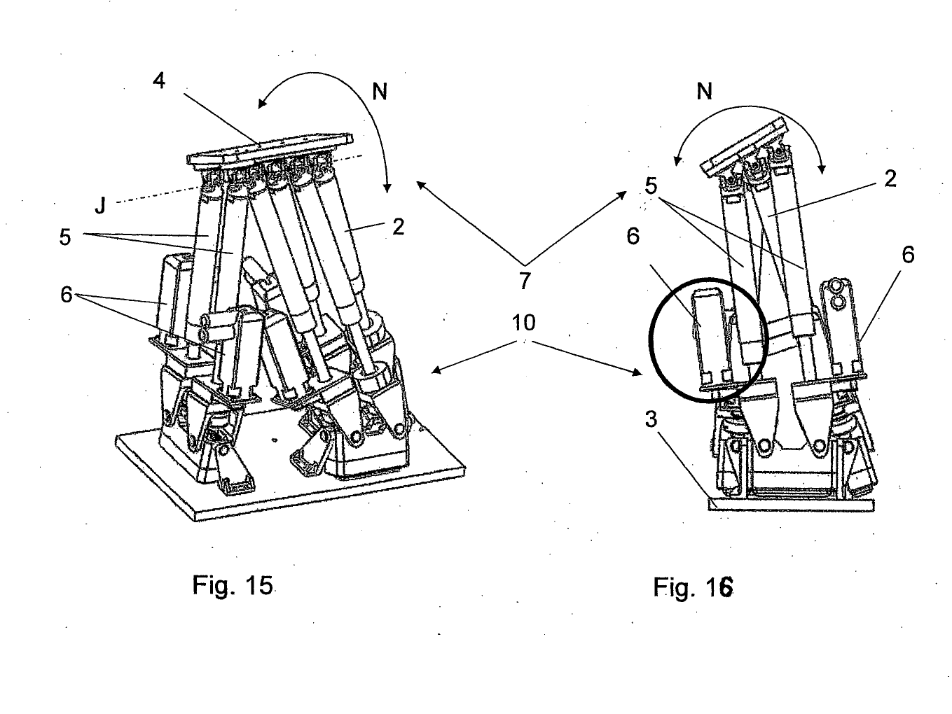

FIG. 15 shows a diagrammatic illustration of a further exemplary embodiment in a side view,

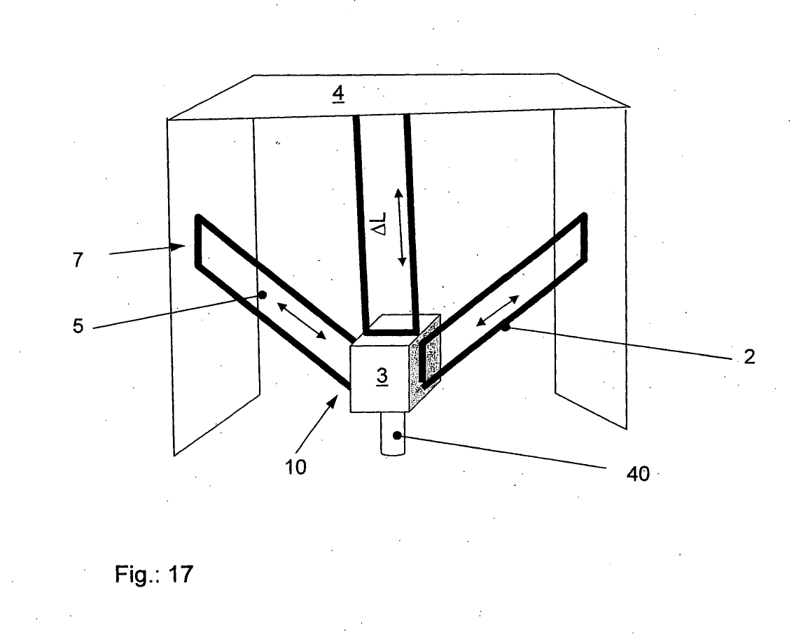

FIG. 16 shows a diagrammatic illustration of a further exemplary embodiment in a front view, and

FIG. 17 shows a diagrammatic three-dimensional illustration of a further exemplary embodiment of the jig according to the invention.

FIGS. 1 to 4, 6, 8, 12 to 14 show a jig for the positioning of articles 1 (see, in particular, FIGS. 6 and 8), with length-adjustable props 2, with a base part 3 and with a receptacle 4 for the article 1. The props 2 are arranged between the base part 3 and the receptacle 4 and are in each case mounted movably on these, as will be explained in more detail further below.

The pair of props which are located on the left in FIG. 2 is considered in more detail below; the other two pairs of props 5a, 5b are constructed identically.

According to the invention, at least one pair of props with two props 2 running parallel is provided. Both the pair of props 5 and the other pairs of props are in the form of a parallelogram. Furthermore, according to the invention, a drive and control unit 6 is provided, in which the drive and control are combined, see, in particular, FIG. 2. At least one drive unit is assigned an encoder which serves for detecting the drive position.

Two pivot bearings 8, 9 are provided at the receptacle-side end 7 of the prop 2 (see FIG. 1 in which the jig is illustrated diagrammatically), which pivot bearings 8 are fixedly connected to the receptacle, which means that the distance between the pivot bearings 8 is invariable. The two pivot bearings 8 of the pair of props 5 have a common pivot axis A. At the base-part-side end 10 of each prop 2, further pivot bearings 11, 12, 13 are provided, of which the pivot bearings 11, 13 possess a pivot axis B. In the position illustrated in FIG. 1, the distance of the pivot axes 8 from the pivot axes 11, 13 is designated by ΔL. By the lengths of the props 2 being varied, the distance ΔL can be varied, so that the distance between the pivot axes 8, 11, 13 can be increased to ΔL₁. This may take place, on the one hand, in that, with the receptacle part 4 virtually being retained, the base part 3 is lowered, so that the pivot axes 11, 13 come to lie on the line C, and, on the other hand, in that, with the base part 3 being retained, the receptacle part 4 is raised from the distance ΔL to the distance ΔL₁. The lowering of the base part 3 may take place, for example, when certain jobs are also to be carried out on the article mounted on the receptacle part 4, and therefore the receptacle part 4 must also remain stationary in space. Normally, however, the base part 3 is stationary and the receptacle part 4 moves.

Reference is made to FIG. 2.

The jig 10 illustrated in FIG. 2 comprises three pairs of props 5, 5a, 5b which are designed essentially identically, the props 2 of each pair of props 5, 5a, 5b in each case spanning a plane which forms a triangle with the other planes in each case. The base-part-side ends of the props are fastened fixedly to U-shaped first bearing blocks 14, 15, specifically on the outside of each crosspiece 16, 17. The legs 18, 19 of each bearing block 15, 16 (the legs of the bearing block 15 are concealed) receive in each case an axis of rotation 20, which axes of rotation are mounted rotatably in a carrier block 21 which is itself mounted, in turn, via an axis 22 on support blocks 23 fixedly connected to the base part 3. The axis 22 runs in the plane which the props of the pair of props 5 span or parallel to this and, furthermore, also parallel to the plane of the base part. As is evident from FIG. 2 particularly with regard to the pair of props 5b, two support blocks 23a and 23b are provided, in which the axis 22 is mounted rotatably; the carrier block 21 which is located between the support blocks 23a, 23b is mounted rotatably via the axis 22, and the bearing blocks 14, 15 are mounted pivotably on this carrier block 21, the pivot axes 20 or axes 20 running transversely or perpendicularly with respect to the axis 22. The support blocks 23a, 23b, the carrier block 21 and the bearing blocks 14, 15 may form together with the pivot axes 20 and 22 a combined universal joint for a pair of props 5, 5a, 5b. Alternatively, to provide the desired movability, two individual universal joints may also be used, the pivot axes of which must then be oriented kinematically in an equivalent way to the pivot axes 20 and 22. Only one drive and control unit 6 or at least one drive unit with an assigned encoder for detecting the drive position 6 is provided for each of the three pairs of props 5, 5a, 5b, the two props 2 of each pair of props 5, 5a and 5b being synchronized with the drive and control unit. A parallelism of the two props 2 of all the pairs of props 5, 5a and 5b is brought about in that the distance between the base-part-side ends 10 and the receptacle-side ends 7 of the two props 2 of all the pairs of props is in each case identical.

The connection of the props 2 of each pair of props 5, 5a and 5b to the receptacle part 4 takes place in each case via a universal joint 24 which is explained in more detail with reference to FIG. 3. The universal joint 24 comprises a first joint part 25 which is connected fixedly to the extendable portion 26 of each prop. Shackles 27, 28 are arranged, here integrally formed, on generatrices of the first joint part 25 which lie distally opposite one another, which shackles receive a pivot axis 29, about which can rotate a cardan joint crosspiece 30 located between the shackles 27, 28. Fastened to the receptacle part 4 is a second joint part 31 which has shackles 32 corresponding to the shackles 27, 28 and projecting towards the first joint part 25, that is to say away from the receptacle part 4. The cardan joint crosspiece 30 is also located between the two shackles 32 and is mounted pivotably on these via an axis 33, the axes 29 and 33 running perpendicularly with respect to one another and either being capable of intersecting at a point or intersecting at a defined distance from one another. Alternatively, the two universal joints may be combined into a combined universal joint, in which the two cardan joint crosspieces are coupled rigidly to one another on their common pivot axis 33, or both cardan joint crosspieces 30 may be combined in one structural part in a similar way to the carrier block 21. Consequently, the prop 2 can pivot in the direction of the double arrow P₂ about the axis 29 and, together with the cardan joint crosspiece 30, about the axis 33, running perpendicularly thereto, in the direction P₃ perpendicularly with respect to the plane spanned by the two props 2, that is to say towards this and away from this. The base part 3 (FIG. 2) is designed in the form of a hexagonal platform; the receptacle 4 is designed as a circular platform with mounting orifices 34.

As illustrated above, a pivot bearing 15, 16 is provided at the base-part-side end of the props 2 or of the pair of props 5a for each prop 2, the distance between which pivot bearings corresponds to the distance between the two universal joints 24 at the receptacle-side end 7 of the props 2. The pivot bearings 15, 16 are mounted with their bearing axes such that they are pivotable perpendicularly with respect to the pivot axis 22. The pivot axis 22 in this case lies tangentially on an imaginary circle which extends about the centre point M of the base part 3 and the radius of which is determined by the pivot axis 22. Mounted on the carrier block 21 is a carrier 35 on which the drive and control unit 6 is fastened, so that the drive and control unit 6 can pivot together with the carrier block 21.

It is evident from FIG. 4 that the base-part-side ends 10 and the receptacle-side ends 7 of the three pairs of props 5 are arranged in each case in the form of an imaginary triangle DA and DB illustrated by dashes particularly in FIG. 4.

It is illustrated further above that the pairs of props in each case span a plane, which planes in each case form a triangle with one another. In this case, the triangle at the base-part-side ends of the pairs of props 5, 5a, 5b is larger than the triangle which the planes at the receptacle-side end of the pairs of props 5, 5a and 5b form with one another. In the illustration and explanation relating to FIG. 4, this also applying to the following illustration, the imaginary triangles are formed in that the pairs of props are in each case interpreted as a unit, which units possess a common centre point in the region of the base-part-side ends and at the receptacle-side ends; these centre points then in each case form the triangle DA, DB, which triangles are pivoted through 60° with respect to the triangles formed by the planes of the pairs of props. The distance E between the adjacent receptacle-side ends 7 of the three pairs of props 5 is shorter than the distance F between the adjacent base-part-side ends 10 of the three pairs of props 5. In other words: the side length E of the receptacle-side triangle DA is smaller than the side length F of the base-part-side triangle. The receptacle 4 is smaller in area than the base part 3. The triangles DA and DB and also the distances E and F may also be gathered from FIGS. 5 and 7 relating to the second and the third variant of the first exemplary embodiment. The area ratios of the receptacle 4 to the base part 3 are illustrated in FIGS. 6 and 8. These also show, in the positions of the examples, the geometries, appropriate for different space conditions, of the receptacle 4 and of the base part 3, and also the article 1 in the form of a tool on the receptacle 4 designed as a platform.

The first (FIG. 4) and the third (FIG. 7) variant of the first exemplary embodiment show in each case the design of an imaginary equilateral triangle DA, DB and the corresponding arrangement of the three pairs of props 5, see FIG. 7. In the second variant, the two imaginary triangles DA, DB are of isosceles design, see FIG. 5.

The third variant differs from the first variant of the first exemplary embodiment in that the imaginary triangle DB formed by the base-part-side ends 10 and the imaginary triangle DA formed by the receptacle-side ends 7 are rotated with respect to one another, as may be gathered from FIG. 7. The angle of rotation between the receptacle-side end 7 and the base-part-side end 10 is designated by a. The corner points, not designated in any more detail, of the imaginary triangles in FIGS. 4, 5 and 7 are intended to indicate the centre between the props 2, at a constant distance from one another, of each pair of props 5, both at its receptacle-side end 7 and at its base-part-side end 10.

In the second exemplary embodiment shown in FIGS. 9 to 11, 10a and 11a, three pairs of props 5 are likewise provided, but the arrangement of the three pairs of props with respect to one another is different from in the first exemplary embodiment. The base-part-side ends 10 of two pairs of props 5 are arranged opposite one another. The third pair of props 5D extends orthogonally with respect to the two opposite pairs of props 5. The variant shown in FIG. 9 indicates at I the distance I between the two base-part-side ends 10 of the opposite pairs of props 5 in the direction of their parallel pivot axes B. In the variant shown in FIGS. 10 and 11, there is no distance I, since no offset of the base-part-side ends 10 occurs there, but, instead, there is a symmetrical arrangement with respect to an imaginary line J.

In the second exemplary embodiment, too, the receptacle-side end 7 of one pair of props 5 is at a shorter distance F from the other receptacle-side end of the next pair of props 5 than the corresponding base-part-side ends 10 of the pairs of props 5 having the distance E, although this is not illustrated for the sake of clarity.

According to the first and second variants of the second exemplary embodiment which are shown in FIGS. 9 and 10, the receptacle-side ends 7 of the two opposite pairs of props 5 form an aligned row on the imaginary line J, parallel to the pivot axes B of the base-part-side ends 10 of the opposite pairs of props 5.

In the arrangement according to FIG. 9, the props of the pairs of props 5, which lie opposite one another, run parallel to one another and perpendicularly with respect to the imaginary line J; the props of the pair of props 5D then run parallel to the line J.

In the version according to FIG. 10, the props of the pairs of props 5 lying opposite one another run at an angle with respect to the imaginary line J, so that the base-part-side ends 10 assume a distance L₁ from the receptacle-side ends 7, as measured in the direction of the imaginary line J. The receptacle-side ends 7 which lie adjacently opposite one another on the line J have a distance K.

The third variant illustrated in FIG. 11 has two opposite pairs of props 5 with receptacle-side ends 7 which span the imaginary line J parallel to the bearing axis B of the base-part-side ends 10 of the pair of props 5 which lies opposite in each case. Moreover, the receptacle-side ends 7 have a distance K parallel to the imaginary line J. The distance K is identical in all the variants of the second exemplary embodiment. The difference between the first and the second variant is, once again, that, in FIG. 9, the distances I and K have the same amount, while the distance I in FIG. 10, but also in FIG. 11, is zero. In the example according to FIG. 9, the distance L between the base-part-side and the receptacle-side end of the prop of a pair of props in each case is zero.

In the third variant of the second exemplary embodiment, the receptacle-side ends 7 of the two opposite pairs of props 5 cross one another, without impairing the range of action of the other pair of props 5 in each case.

FIG. 12 shows a variant which is derived from FIG. 9. In this case, a distance L, which is measured perpendicularly to the line J, is present between the base-part-side end 10 and the receptacle-side end 7 of the pair of props 5D.

The version according to FIG. 13 is a variant of the version according to FIG. 11, here likewise a distance L between the base-part-side end 10 and the receptacle-side end 7 of each prop of the pair of props 5b being provided, which is measured perpendicularly to the imaginary line J.

In the versions of FIG. 9 to 13, essentially the same reference numerals have been used, and the designation L likewise for all the distances, although, in the individual variants of FIGS. 9 to 13, the distances L may perfectly well be different, this also applying to the dimensioning of the distances K. It should also be added that the distances of the pivot axes B from the imaginary line J are designated in FIG. 9 by U, in FIGS. 10 and 11 by U₁ and U₂, in order to indicate that, if appropriate, these distances may also vary and be different.

In order to allow different load absorptions, different positions are assumed. In this case, as shown in the first variant, within a pair of props, an arrangement lying opposite one another may be adopted or, as shown in the second and the third variant, an arrangement of the receptacle-side end 5 lying, offset, opposite the base-part-side end 10. In the second and the third variant of the second exemplary embodiment, therefore, a distance L between the receptacle-side end 7 and the base-part-side end 10 of a pair of props 5 is present, but not in the first variant of the second exemplary embodiment. On the pairs of props lying opposite one another, the distance L may either by designed in each case to have the same amount or to have a different amount on each pair of props, as already indicated above. The same also applies to the distances U, U₁ and U₂. Furthermore, a distance L between the receptacle-side end and the base-part-side end of a pair of props may also be possible on the third orthogonally arranged pair of props, as illustrated in FIGS. 12 and 13.

The positioner shown by way of example in FIG. 14 shows that the plate-shaped base part 3 is of rectangular design and that the receptacle 4 is likewise of plate-shaped and rectangular design.

Two further configurations of positioners (FIGS. 15 and 16) illustrate a fourth variant of the second exemplary embodiment. In contrast, here, the two props 2 of the pair of props 5 extending orthogonally with respect to the two pairs of props 5 lying opposite one another are driven separately and have in each case a specific drive and control unit 6 or at least one drive unit with an assigned encoder for detecting the drive position, this drive unit being emphasized by a circle in FIG. 13b. The tilting or pivoting movement designated by the arrow N can thereby be implemented. The arrangement of the pairs of props 5 corresponds to the first variant according to FIG. 9 with offset base-part-side ends 10 and with an arrangement of the receptacle-side ends 7 of the opposite pairs of props 5 in an aligned row.

Finally, FIG. 17 shows diagrammatically a third exemplary embodiment of the jig according to the invention, the base part 3 being in the form of a cube. A pair of props 5 is arranged in each case on three of five possible side faces of the cube. A mounting 40 for the base part 3 is arranged on the sixth side face of the cube. The receptacle 4 is designed in the form of a frame-shaped structural part which extends 3-dimensionally and is connected to the receptacle-side ends of the three pairs of props 5.

In conclusion, it may be pointed out that the teaching according to the invention is not restricted to the exemplary embodiments discussed above. On the contrary, the most diverse possible designs of the base parts and receptacles in space-saving polygonal forms or with different spatial dimensions are possible. There are, in principle, also many possibilities afforded in terms of the synchronization of the props 2 and the transmission of force from the drive and control unit 6 to the props 2.

It should be stated, once again, that the base-part-side ends and the receptacle-side ends of the props of a pair of props in each case possess the same distance from one another which is invariable.

1. Jig particularly for the positioning of articles,
with length-adjustable props,
with a base part,
with a receptacle for the article,
the props being arranged between the base part and the receptacle and being in each case mounted movably there, and
with a drive and control for adjusting the props, wherein at least one pair of props is formed from two props which run parallel to one another and with one another to form the shape of a parallelogram.

2. Jig according to claim 1, wherein at least one prop of at least one pair of props can be activated for length adjustment by means of a drive and control device or at least one drive unit with an encoder, assigned to the latter, for detecting the drive position.

3. Jig according to claim 2, wherein the at least one prop is spatially assigned the drive device and can be moved by means of the latter.

4. Jig according to claim 2, wherein the drive and the control device form a spatial unit.

5. Jig according to claim 2, wherein the control device is arranged spatially separately from the drive device, if appropriate is accommodated in a switch cabinet.

6. Jig according to claim 2, wherein the two props of the at least one pair of props are synchronized by means of the drive and control unit.

7. Jig according to claim 1, wherein the receptacle is connected in an articulated manner and non-displaceably to the receptacle-side end of the at least one pair of props.

8. Jig according to claim 1, wherein the base part is designed as a platform or as a supporting framework, on the top side of which the at least one pair of props is arranged.

9. Jig according to claim 1, wherein three pairs of props are provided.

10. Jig according to claim 9, wherein the base-part-side ends and the receptacle-side ends of the three pairs of props are arranged in each case in the form of an imaginary triangle (DA, DB).

11. Jig according to claim 10, wherein the distance (E) between the receptacle-side ends of at least three pairs of props is shorter than the distance (F) between the base-part-side ends of the three pairs of props.

12. Jig according to claim 10, wherein the imaginary triangle (DA, DB) is equilateral.

13. Jig according to claim 10, wherein the imaginary triangle (DA, DB) is isosceles.

14. Jig according to one of claim 10, wherein the imaginary triangle (DB) formed by the base-part-side ends and the imaginary triangle (DA) formed by the receptacle-side ends are rotated with respect to one another.

15. Jig according to claim 8, at least three pairs of props being provided, wherein the base-part-side ends of at least two pairs of props lie opposite one another on a first and a second line, which runs parallel to one another, and the base-part-side ends of the third pair of props lie on a third line, which runs perpendicularly with respect to the first and the second line.

16. Jig according to claim 15, wherein at least the base-part-side ends of the pairs of props lying opposite one another are at a distance from another in the direction of their parallel pivot axes (B) or of the first and the second line.

17. Jig according to claim 1, wherein the receptacle-side ends of the pairs of props are at a shorter distance from one another than the base-part-side ends of the pairs of props.

18. Jig according to claim 17, wherein the receptacle-side ends of the two pairs of props lying opposite one another form an aligned row on an imaginary line (J) parallel to the first and the second line of the base-part-side ends of the pairs of props lying opposite one another.

19. Jig according to claim 17, wherein the receptacle-side ends of each of the two pairs of props lying opposite one another span at least partially an imaginary line (J) extending parallel to the pivot axes (B) or the first and the second line of the base-part-side end of the pair of props lying opposite in each case.

20. Jig according to claim 19, wherein the receptacle-side ends of the two pairs of props lying opposite one another cross one another at least with respect to one prop, without impairing the range of action of the other pair of props in each case in a defined working range.

21. Jig according to claim 20, wherein the receptacle-side ends of the props of the pairs of props lying opposite one another lie on both sides of an imaginary fourth line (J), the props of the two pairs of props crossing over the imaginary fourth line (J).

22. Jig according to claim 15, wherein the distance (L) between the receptacle-side end and the base-part-side end of a pair of props of the two pairs of props lying opposite one another, as seen in the direction of their pivot axes (B), is equal to zero.

23. Jig according to claim 15, wherein the receptacle-side end of a pair of props of the two pairs of props lying opposite one another at a distance (L), as seen in the direction of the pivot axis (B) of the base-part-side end of the same pair of props.

24. Jig according to claim 15 wherein the plate-shaped base part is of rectangular design, and in that the receptacle is likewise of plate-shaped and rectangular design.

25. Jig according to claim 15, wherein at least the two props of at least one pair of props are driven separately.

26. Jig according to claim 25, wherein the two separately driven props are those of which the pair of props runs orthogonally with respect to the two pairs of props lying opposite one another.

27. Jig according to claim 1, wherein the base part is designed in the form of body, on the circumference of which the pairs of props are arranged.

28. Jig according to claim 27, wherein the base part is in the form of a cube.

29. Jig according to claim 28, wherein three side faces of the cube are assigned in each case a pair of props, the pairs of props extending orthogonally with respect to one another at least in a position in the working range.

30. Jig according to claim 27, wherein the receptacle is in the form of a frame-shaped structural part.

31. Jig according to claim 15, wherein the receptacle-side end of a pair of props of the two pairs of props lying opposite one another have a distance (L) in the direction of the pivot axis (B) of the base-part-side end of the same pair of props, the distance (L) being dimensioned with a different amount for each pair of props.

32. Jig according to claim 15, wherein the distance (U) between the foot points of the receptacle-side and base-part-side ends with respect to the imaginary line (J) on the two pairs of props lying opposite one another is dimensioned with either identical or different amounts.
